(19) United States
(12) Patent Application Publication
(10) Pub. No.: US 2015/0193405 A1
(43) Pub. Date: Jul. 9, 2015

(54) ENHANCED TESTING FOR APPLICATION SERVICES

(71) Applicant: Microsoft Corporation, Redmond, WA (US)

(72) Inventors: David Samuel Thal Gensburg, Seattle, WA (US); Kartik Nathan, Bellevue, WA (US); Jenefer Monroe, Seattle, WA (US); Chad Barry Rothschiller, Edmonds, WA (US)

(73) Assignee: Microsoft Corporation, Redmond, WA (US)

(21) Appl. No.: 14/149,486

(22) Filed: Jan. 7, 2014

(51) Int. Cl. G06F 17/22; G06F 17/24

(52) U.S. Cl. CPC G06F 17/2288; G06F 17/246

(57) ABSTRACT

Systems, methods, and software are disclosed herein for implementing enhanced testing for application services. In an implementation, revisions are made to a document in the context of an application service. The revisions invoke responses by at least a subset of the components of the service. At least some of the same revisions may then be applied to another instance of the document subject to various test components. Responses by the test components are invoked by the revisions, which may then be compared against the other responses to evaluate the test components.

### TECHNICAL FIELD

Aspects of the disclosure are related to computing hardware and software technology, and in particular, to enhanced testing for application services.

### TECHNICAL BACKGROUND

Many software applications have often been provisioned and delivered as native applications that are locally installed and executed. Prior to releasing and shipping a new version of a given application, the application is typically tested in order to discover bugs and other issues. However, in many cases applications are released that have bugs that go undiscovered until customers begin interacting with the applications in their varied ways. Bug fixes can be rolled out in patches, upgrades, or in the new version of an application, although this can be time consuming and fixes may not reach all parties.

Applications are increasingly provided at least in part as application services that are hosted in a data center or other computing facility and to which client devices and applications connect to access a service. Examples include the various application services available from Microsoft® under the Office 365® offering, such as Word®, Excel®, and PowerPoint®, among other products. Application services like these are updated frequently as new features are developed or existing features are improved.

As enhancements are made to the various components of an application that is delivered as a service, the components are tested in a development environment against models that simulate how customers may interact with a service. When ready, the enhancements are released to a production environment for wider access to customers. However, as in the past, even very robust testing generally cannot detect each and every bug that may exist in an application service. Moreover, such testing typically occurs late in the development cycle, close to when enhances are scheduled for release.

Once discovered, bugs can be repaired faster than ever, but in the interim customers remain exposed to bugs and their consequences. Software bugs are especially troublesome to discover in the context of updating an application service to support collaboration. For example, in Excel® some components function to ensure that formulas, cell references, and other spreadsheet characteristics remain valid as revisions are made to a spreadsheet. Updating those and other components to support collaboration introduces the potential for software bugs that are difficult to detect with traditional testing.

### OVERVIEW

Provided herein are systems, methods, and software for implementing enhanced testing for application services. Various implementations enable passive testing in an application service such that improvements to the application service may be tested with observed revisions to documents without disturbing the documents or the user experience.

In at least one implementation, revisions are made to a document in the context of an application service that invoke responses by at least a subset of the components of the service. At least some of the same revisions may then be applied to another instance of the document subject to various test components. Responses by the test components are invoked by the revisions, which may then be compared against the other responses to evaluate the test components. In this manner, more bugs may be discovered than with traditional testing.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational scenario in an implementation.

FIG. 2 illustrates an enhanced testing process in an implementation.

FIG. 3 illustrates an operational scenario in an implementation.

FIG. 4 illustrates an enhanced testing process in an implementation.

FIG. 5 illustrates a spreadsheet in an implementation.

FIG. 6 illustrates revisions to a spreadsheet in an implementation.

FIG. 7 illustrates various component responses invoked by revisions to a spreadsheet in an implementation.

FIG. 8 illustrates various test component responses invoked by revisions to a test spreadsheet in an implementation.

FIG. 9 illustrates a computing system suitable for employing a testing service in an implementation.

### TECHNICAL DISCLOSURE

Implementations disclosed herein refer to enhanced testing for application services. The enhanced testing involves, in at least some implementations, observing revisions that are made by customers or other entities to their documents. The revisions may invoke responses by components of the application service associated with the documents such that the documents are changed in some way.

All or a portion of the same revisions may then be applied to other versions of the same documents, such as copies of the documents. The revisions, when applied to the alternative versions of the documents, invoke responses by components that results in changes to the alternative versions of the documents. The documents in their post-revision states may then be compared in order to evaluate the soundness of the components under test.

In a brief example, code development can be tested by using real customer interactions with their documents to drive testing of new code developed for an application service. This may be especially useful in the context of application services that are provisioned and delivered in data centers and for which rapid and frequent code improvements are the norm. Other contexts in which such testing may be useful include when extensive or deep architectural changes are made to an application service such that subtle variations in behavior may be difficult to detect.

In this example, a customer engaged with an application service may open a document to make revisions to it. Examples of the application service include, but are not limited to, a spreadsheet application service, a word processing application service, and a presentation application service. Examples of the document include, but are not limited to, a spreadsheet workbook, a word processing document, and a presentation document.

As the revisions are made, various components of the application service are invoked and respond to the revisions, thereby changing the document. The revisions are monitored by the enhanced testing service and at least some of the revisions are applied to a copy of the document subject to various components being tested, also changing the copy of the document. Both documents in their post-revisions states may be compared to evaluate the components under test. Inconsistencies between the two documents may indicate that at least one of the components under test has a bug and needs repair.

In this example, a single document revised by a single user is illustrated, although it may be appreciated that such enhanced testing may be applied in the context of more than one user and more than one document. Indeed, at greater scale such enhanced testing may involve a large number of users, documents, and revisions made to the documents. At such scale, the variety of documents and revisions used to test new components or updated components may uncover more bugs in the components under test than if traditional testing alone were employed. It may be appreciated that such traditional testing may be still be employed in addition to the enhanced testing disclosed herein and it is not intended that other types of testing be eliminated.

In some scenarios, a separate build of an application service may be employed that includes various test components. In such scenarios, an original version of a document is opened in one build of the application service, while a copy of the document may be opened in the separate build such that revisions to it are processed by the test components. In other scenarios, the same build of an application service, but with at least some different components, may be used to process the copy of the document.

In at least one implementation, a testing service tests components in an application service by identifying at least a subset of revisions made to a document that invoke responses by at least a subset of the components in the application service. The testing service applies the subset of the revisions to a test document to invoke test responses by test components corresponding to the subset of the components. The test components may then be evaluated based at least in part on a comparison of the responses by the subset of the components to the test responses by the test components.

In some implementations, the testing service selects the document for testing from various documents based at least in part on a relevance of the test components to each of the documents. The testing service may then monitor for when the document is opened, in response to which the testing service creates the test document prior to any of the revisions occurring. The revisions may be monitored for those that invoke responses by specific ones of the components identified for development. The test service may also monitor for when the document is closed and apply the subset of the revisions in response thereto. After closing the document and after the revisions are made, the document can be compared to the test document to generate the comparison of the responses to the test responses.

Other ways in with to deploy a testing service include randomly selecting documents for testing. In an example, one percent of a given set of document sessions could be selected for testing purposes. In other situations, documents associated with a particular machine, cluster, or data center could be identified for testing. Machines, clusters, or data centers that exhibit high health scores could be used for testing, while other machines, clusters, or data centers could be bypassed so as not to burden their operations.

In some implementations, the application service is a spreadsheet application service and the document is a spreadsheet workbook. In some scenarios, the test document is a copy of the document. Examples of the revisions may include, but are not limited to, an edit to a first portion of a spreadsheet in the spreadsheet workbook that implicates at least a second portion of the spreadsheet in the spreadsheet workbook. Examples of the responses include, but are not limited to, at least one of the subset of the components effecting a change with respect to the second portion of the spreadsheet in response to the edit. Examples of the edit include a row insertion, a row deletion, a column insertion, a column deletion, a cell value edit, and a formula edit. Examples of the change include changing a cell reference, changing a formula, and changing a cell value.

Some implementations may involve collaboration scenarios. In a spreadsheet-centric example, a testing service identifies revisions made by various users collaborating on a spreadsheet. The revisions invoke responses by components that provide at least a portion of the spreadsheet service. The test service applies the revisions to a copy of the spreadsheet to invoke test responses by test components. After the revisions, the spreadsheet may be compared to the copy of the spreadsheet to identify potential bugs associated with the test components. Depending upon its implementation, the spreadsheet service may include a calculation engine and a rendering engine. The components may be representative of a first subset of components for the calculation engine and a second subset of components for the rendering engine. As such, the test components may be representative of a new version or versions of the components.

It may be appreciated that not only can code development be tested for how accurately or properly some functions are carried out, but performance can also be tested. For example, new code can be tested for how long it takes to recalculate a workbook compared to how long a previous version of a service takes to recalculate the workbook. Another example includes memory consumption in which the memory consumed by one version of a service to load a workbook or perform some other task is compared against how much memory is consumed by a previous version.

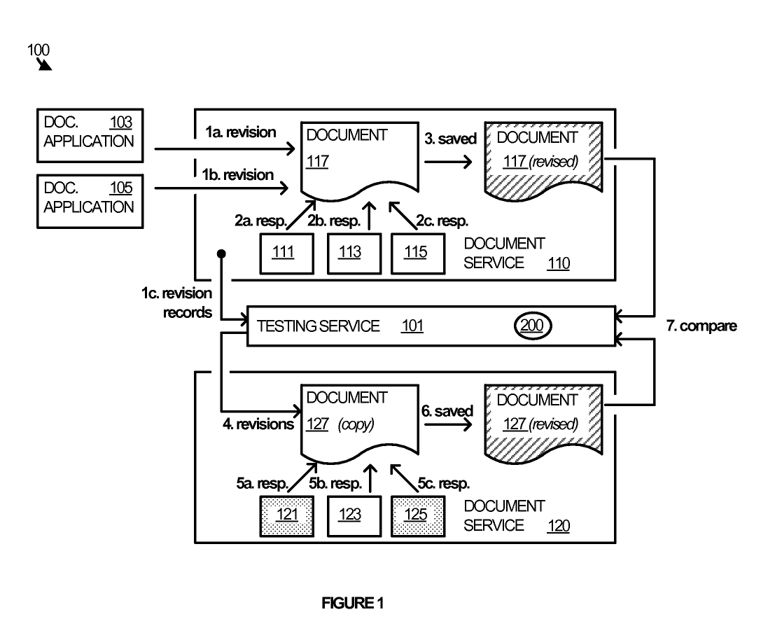

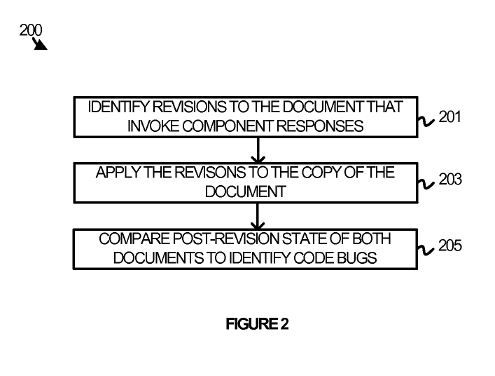

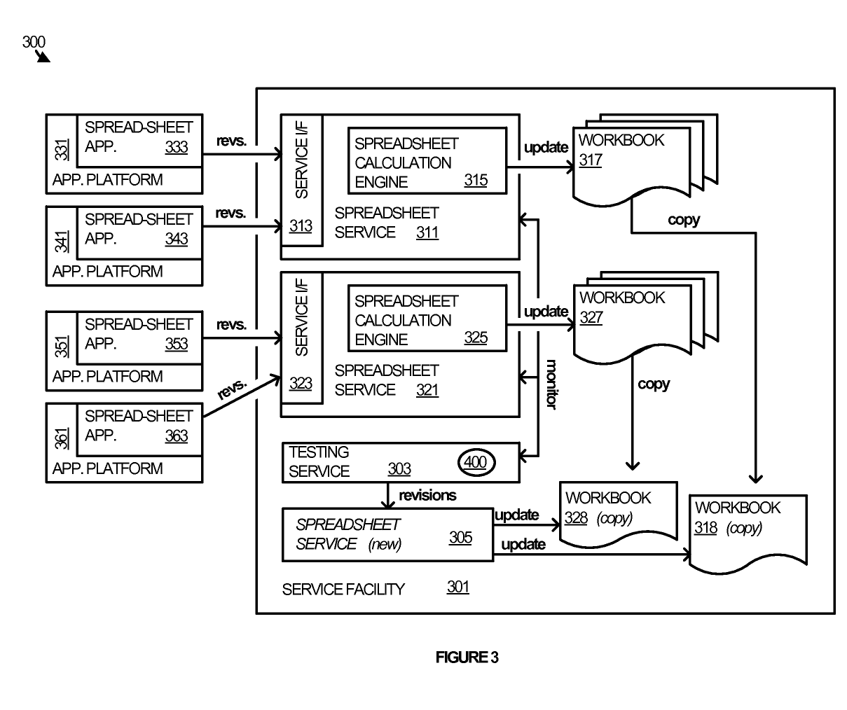

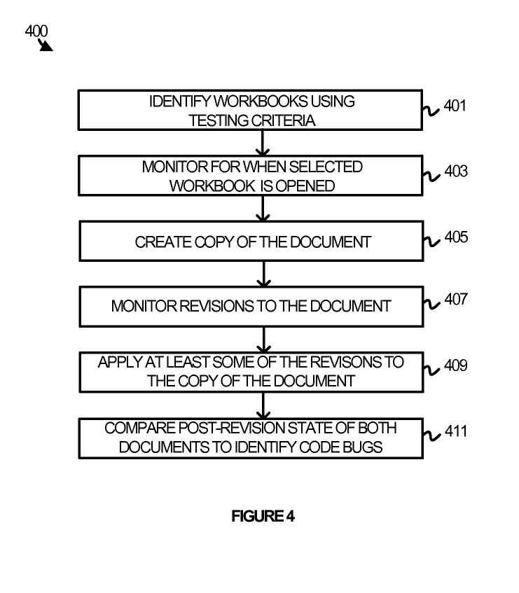

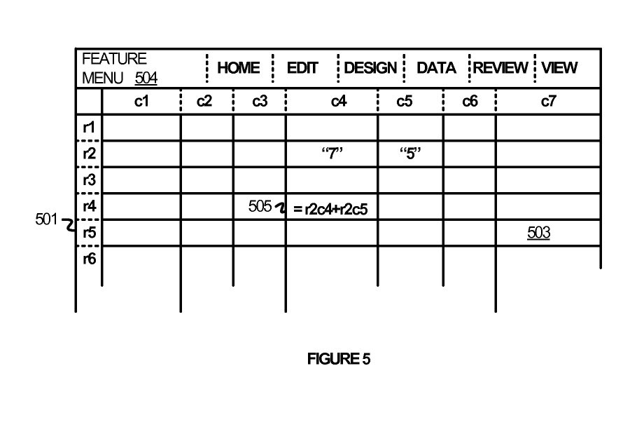

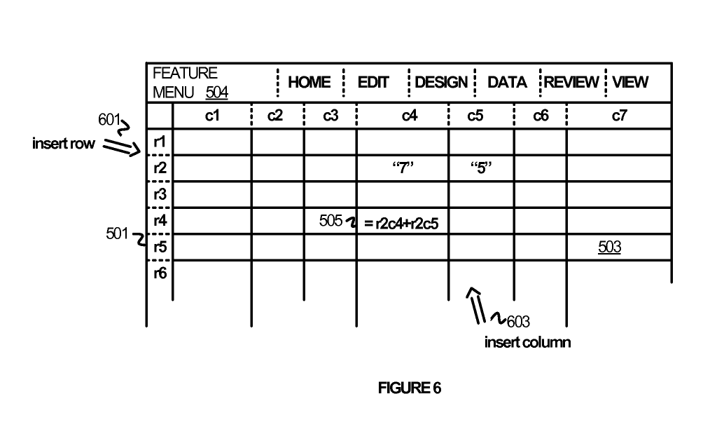

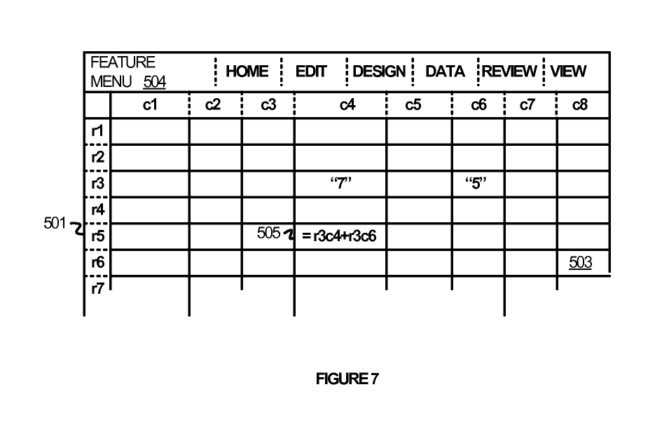

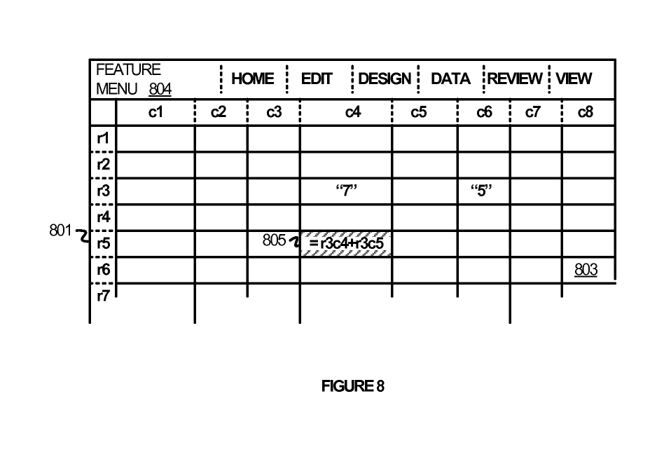

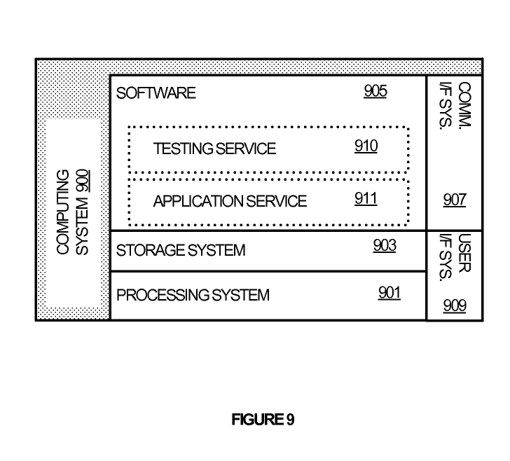

Referring now to the drawings, FIG. 1 illustrates an operational scenario involving a testing service. FIG. 2 illustrates an enhanced testing process that may be employed by the testing service. FIG. 3 illustrates another operational scenario and FIG. 4 illustrates another enhanced testing process. FIG. 5 illustrates an exemplary spreadsheet, while FIG. 6 illustrates revisions to the spreadsheet that may be used for testing purposes. FIG. 7 illustrates component responses to the revisions. FIG. 8 illustrates responses made by components under test in view of the same revisions. FIG. 9 illustrates a computing system representative any that may be used to implement the testing service and processes.

In operational scenario 100, illustrated in FIG. 1, a testing service 101 employs an enhanced testing process 200 to test service improvements using actual revisions made to documents. Users interact with document service 110 by way of document applications, such as document application 103 and 105. The same revisions made to the documents within the context of document service 110 are then applied to another version of the document, but within the context of document service 120. Each document may then be compared to each other to identify bugs in document service 120. Operational scenario 100 is illustrative of a collaborative situation in which multiple people work on a shared document, document 117, but it may be appreciated that such collaboration is merely exemplary and non-collaborative scenarios are within the scope of the present disclosure.

Testing service 101 is representative of any software application, module, component, or collections thereof capable of employing enhanced testing process 200 in support of testing improvements to all or portions of document service 110. The improvements may be employed in a different instance or version of document service 110, of which document service 120 is representative. Testing service 101 may be implemented in a stand-alone fashion or may be implemented in an integrated or cooperative fashion with respect to document service 110 and document service 120. Various types of physical or virtual computing systems may be used to implement enhanced testing process 200 within the context of testing service 101, of which computing system 900, discussed below with respect to FIG. 9, is representative.

Document service 110 is representative of any application service in which revisions may be made to documents. Examples of document service 110 include, but are not limited to, spreadsheet application services, word processing application service, presentation application services, blogging services, gaming services, and personal information management services, as well as any other suitable application service, combination, or variation thereof. Document service 110 may be hosted in a data center or some other suitable computing facility. Various types of physical or virtual computing systems may be used to implement document service 110, such as application servers, database servers, mail servers, rack servers, blade servers, tower servers, or any other type of computer server, variation or combination thereof, of which computing system 900, illustrated with respect to FIG. 9, is representative.

Document application 103 and document application 105 communicate with document service 110 in order to provide users with access to document service 110. Document application 103 and document application 105 are each representative of any software application capable of interfacing with document service 110 to allow users to engage with and edit documents. Examples of document application 103 and document application 105 include, but are not limited to, spreadsheet applications, word processing applications, presentation applications, personal information management applications, blogging applications, and gaming applications, as well as any other suitable type of application, combination of applications, or variation thereof.

Document application 103 and document application 105 may each be a locally installed and executed application, a streaming application, a hosted application that runs in the context of a browser application, a mobile application, or any combination or variation thereof. Various types of physical or virtual computing systems may be used to implement document application 103 and document application 105, such as server computers, desktop computers, laptop computers, tablet computers, smart phones, gaming appliances, or any other suitable computing appliance, of which computing system 900, discussed below with respect to FIG. 9, is representative.

In operation, users engage with document application 103 and document application 105 to make revisions to document 117. Document service 110 includes various software components of which component 111, component 113, and component 115 are representative. At least some of the revisions invoke responses by at least some of the components. In this scenario, it is assumed for exemplary purposes that the revisions invoke responses by components 111, 113, and 115. The revisions and responses result in changes to document 117 which, when saved, transitions to a revised state.

Testing service 101 monitors the revisions being made to document 117 such that the same revisions may be made to document 127. In some scenarios, document 127 may be a copy of document 117 that is created when document 117 is opened, although it may be appreciated that document 127 may not be an exact copy and may be some other alternative version of document 117, such as slightly different version of document 117 or a copy of some other document having similar characteristics.

Testing service 101 applies the revisions to document 127 within the context of document service 120. Document service 120 includes various components that correspond to the components of document service 110, of which component 121, component 123, and component 125 are representative. Component 121 may correspond to component 111; component 123 may correspond to component 113; and component 125 may correspond to component 115. Component 121 and component 125 are shaded to represent that they are modified versions of component 111 and component 125. In other words, it may be assumed that some update or modification has been developed for which testing would be beneficial. As such, applying the same revisions to document 127 as were applied to document 117 allows component 121 and component 125 to be tested.

In particular, testing service 101 applies the revisions to document 127, which invoke responses by components 121, 123, and 125. The revisions and responses result in a revised version of document 127, which is saved. The revised version of document 127 may then be compared by testing service 101 to the revised version of document 117 to identify any differences. The differences, if any are discovered, may related to functions or features performed by any of components 121, 123, and 125, which would alert developers to problems or bugs in the code associated with the components.

FIG. 2 illustrates enhanced testing process 200 carried out by testing service 101 in the context of operational scenario 100. In operation, testing service 101 identifies revisions to document 117 that invoke responses by the various components 111, 113, and 115 of document service 110 (step 201). Testing service 101 may monitor communications exchanged between document applications 103 and 105 and document service 110 in order to identify the revisions. In other scenarios, document service 110 may maintain a log of revisions as they occur and which can be reported to testing service 101. A variety of ways for monitoring the revisions are possible and may be considered within the scope of the present disclosure.

Upon identifying the revisions to document 117, testing service 101 applies the revisions to a copy of document 117, represented by document 127 (step 203). Testing service 101 may apply the revisions in a variety of ways, such as by interfacing with document service 120 as if testing service 101 were an instance of a document application. In other words, testing service 101 may be capable of making service calls to document service 120 just as an instance of a document application would. In other implementations, a testing interface may be developed that allows testing service 101 to communicate the revisions to document service 120 such that document service 120 may implement the revisions. A variety of other ways to apply the revisions to document 127 are possible and may be considered within the scope of the present disclosure.

Once the revisions have been applied to document 127, testing service 101 compares document 127 in its revised state to document 117 in its revised state to identify code bugs (step 205). If document 127 matches document 117, then it may be concluded that the improvements or other changes made to component 121 and component 125 are free of bugs. However, inconsistencies between document 127 and document 117 may be indicative of bugs or other problems associated with component 121 or component 125. Other steps may be included in enhanced testing process 200, such as identifying specifically which bug may be associated with which inconsistency, if any appear, or gathering additional data from the user about the revisions.

FIG. 3 illustrates an operational scenario 300 in which revisions made to workbooks are used to test modifications to a spreadsheet service. In operational scenario 300, service facility 301 hosts multiple instances of a spreadsheet service, of which spreadsheet service 311 and spreadsheet service 321 are representative. Testing service 303 uses revisions made to workbooks through spreadsheet service 311 and spreadsheet service 321 to test a new version of the spreadsheet service, of which spreadsheet service 305 is representative. The revisions may be initiated by various instances of a spreadsheet application, of which spreadsheet application 333, spreadsheet application 343, spreadsheet application 353, and spreadsheet application 363 are representative. Spreadsheet applications 333, 343, 353, and 363 may run on or in the context of application platform 331, application platform 341, application platform 351, and application platform 361 respectively.

Service facility 301 is representative of any physical or virtual computing facility or facilities in which instances of an application service may be hosted and in which a testing service may be employed. Examples of service facility 301 include data centers, virtual data centers, and other facilities in which collections of computing equipment may be located and operated in order to provide application and testing services. Service facility 301 may include various computing systems and other equipment with which spreadsheet service 311, spreadsheet service 321, testing service 303, and spreadsheet service 305 are implemented, of which computing system 900 in FIG. 9 is representative.

Testing service 303 is representative of any software application, module, component, or collections thereof capable of employing enhanced testing process 400 in support of testing improvements to all or portions of a spreadsheet service. The improvements may be employed spreadsheet service 305. Testing service 303 may be implemented in a stand-alone fashion or may be implemented in an integrated or cooperative fashion with respect to spreadsheet service 311, spreadsheet service 321, and spreadsheet service 303.

Spreadsheet service 311 and spreadsheet service 321 are each representative of any spreadsheet application service in which revisions may be made to documents. Examples of spreadsheet services 311 and 321 include, but are not limited to, Microsoft® Excel®, Google® Docs, and Apple® Numbers®, as well as any other spreadsheet service, combination or services, or variation thereof. Spreadsheet service 305 is representative of any modified version of spreadsheet services 311 and 321 for which testing may be useful.

Spreadsheet service 311 includes a service interface 313 and a spreadsheet calculation engine 315. Spreadsheet service 311 communicates with spreadsheet applications via service interface 313. Spreadsheet calculation engine 315 handles calculation tasks and other tasks and processes that support the various features and functions of a spreadsheet. Other elements are possible, such as a rendering engine that functions to render views of a spreadsheet and other aspects of a workbook.

Spreadsheet service 321 also includes a service interface 323 and a calculation engine 325. Spreadsheet service 321 may also include a rendering engine. For illustrative purposes in this implementation, it is shown that spreadsheet applications 333 and 343 communicate with spreadsheet service 311, while spreadsheet applications 353 and 363 communicate with spreadsheet service 321, although it may be appreciated that some other combination is possible and is within the scope of the present disclosure.

Spreadsheet applications 333, 343, 353, and 363 are each representative of any spreadsheet application capable of interfacing with spreadsheet service 311 and spreadsheet service 321. Spreadsheet applications 333, 343, 353, and 363 may be stand-alone applications or may be integrated with some other application or suite of applications. Spreadsheet applications 333, 343, 353, and 363 may be provisioned and delivered in a variety of ways, for example as native applications that are locally installed and executed, a hosted applications that run within the context of a browser application, as streaming applications, or in some hybrid manner that combines aspects of each delivery paradigm, as well as in some other manner, combination, or variation thereof.

Spreadsheet applications 333, 343, 353, and 363 run on, or in the context of, application platforms 331, 341, 351, and 361. Application platforms 331, 341, 351, and 361 are each representative of any suitable physical or virtual platform for running a spreadsheet application and communicating with spreadsheet services 311 and 321. Examples of application platforms 331, 341, 351, and 361 include, but are not limited to, personal computers, laptop computers, tablet computers, mobile computing devices, smart phones, hybrid computing devices, gaming devices, and any combination or variation thereof, of which computing system 900 in FIG. 9 is representative.

In operation, users engage with spreadsheet applications 333, 343, 353, and 363 via application platforms 331, 341, 351, and 361 respectively to make edits and revisions to workbooks 317 and 327. In this implementation, users collaborate on workbook 317 to make collaborative revisions via spreadsheet application 333 and spreadsheet application 343, while collaboration revisions are made with respect to workbook 327 by way of spreadsheet application 353 and spreadsheet application 363. Thus, workbook 317 is hosted by spreadsheet service 311 and workbook 327 is hosted by spreadsheet service 321.

In the case of workbook 317, spreadsheet application 333 and spreadsheet application 343 communicate revisions to service interface 313, which are then implemented by spreadsheet calculation engine 315 or some other component of spreadsheet service 311. The revisions may be communicated in revision records that describe what revisions were made. Workbook 317 is updated with the revisions and saved. In the case of workbook 327, spreadsheet application 353 and spreadsheet application 363 communicate revisions to service interface 323 that are implemented by spreadsheet calculation engine 325, or some other component of spreadsheet service 321.

Testing service 303 monitors revisions being made to workbook 317 and workbook 327. In some implementations, testing service 303 monitors the revisions by receiving a copy of revision records from service interfaces 313 and 323, or some other elements of spreadsheet services 311 and 321. In other implementations, testing service 303 monitors the updates to workbooks 317 and 327 by spreadsheet calculation engines 315 and 325. Other mechanisms for monitoring the revisions are possible and may be considered within the scope of the present disclosure.

Testing service then applies the revisions to copies of workbooks 317 and 327, represented by workbook 318 and workbook 328. The revisions applied to workbook 317 are applied to workbook 318, which is a copy of workbook 317, while the revisions made to workbook 327 are applied to workbook 328, which is a copy of workbook 327.

It may be appreciated that the revisions made to workbook 317 may invoke responses by components of spreadsheet service 311. In an example, the revisions may include edits to formulas in a sheet in workbook 317. One of the components of spreadsheet service 311 may be responsible for ensuring that the formula is valid. In another example, the revisions may include the insertion or deletion of a row or column, the insertion or deletion of a cell or cells, or some other modification to a sheet that impacts the content of various cells. One or more components may be responsible for ensuring the validity of formulas in cells, for changing cell references, and for conducting other operations related to the content of cells and their relationships. Any number of revisions are possible for which responses may be invoked and may be considered within the scope of the present disclosure.

The responses that are invoked by various revisions may include a variety of changes to a spreadsheet. For example, the insertion or deletion of a row or column may invoke a response by a component to automatically change cell references in a formula. In another example, the deletion of a row or column may prompt a response to highlight or otherwise indicate that a cell value or cell formula is invalid. A variety of other responses are possible and may be considered within the scope of the present disclosure.

Accordingly, the same revisions made to workbook 317, when applied to workbook 318, will invoke responses by components that correspond to those invoked with respect to workbook 317. If a component that is invoked is new, then the response that it provides to a revision can be compared against the response provided by its corresponding component to determine whether or not the new component is faulty or has a bug. In the aggregate, an entire sheet or workbook in a revised state can be compared to an original sheet or workbook as revised to determine whether or not new components or other aspects of a spreadsheet service being developed have bugs. In particular, spreadsheet service 305 and its components can be checked by comparing how it responds to revisions relative to how spreadsheet service 311 responded to revisions.

Moreover, the revisions made to workbook 327 can be applied to workbook 328. Any differences between workbook 327 and workbook 328 may be indicative of bugs or other problems with spreadsheet service 305. In the aggregate, testing spreadsheet service 305 based on revisions from multiple users applied to multiple workbooks improves the likelihood of identifying problems in spreadsheet service 305. In this implementation, spreadsheet service 305 is tested based on revisions made to multiple workbooks, workbook 317 and workbook 327. In addition, the revisions originate from multiple sources, implying that a diversity of revisions will be discovered and tested against spreadsheet service 305.

FIG. 4 illustrates an enhanced testing process 400 that may be employed by testing service 303 in the context of operational scenario 300. In operation, testing service 303 identifies which workbooks to use for testing purposes based on testing criteria (step 401). It may be appreciated that some workbooks may be more useful testing purposes than other workbooks. For instance, a workbook having many formulas and cell references may be more useful than a blank workbook for purposes of testing improvements to a spreadsheet service. In another example, testing specific types of updates to a spreadsheet may be more feasible with more workbooks than others. Accordingly, testing criteria can be developed that describes the characteristics of a workbook that would be suitable for a given test. A set of workbooks may be examined to identify those that would be suitable for testing.

In another example, workbooks may be identified for testing based on some other criteria, such as their creation date, the identity of their owner, or by some other criteria. The identity of a sheet's owner may be an individual or possibly an entity, such as a corporation or some other organizational entity. An organizational identity may volunteer or otherwise agree that their workbooks and associated revisions be used for testing purposes. Thus, the step of identifying workbooks for testing may include identify those workbooks associated with a particular individual, corporation, or other such entity. A combination of criteria may also be used, such as identifying those workbooks associated with a particular entity and then a subset of those workbooks that have specific characteristics that satisfy other criteria.

Testing service 303 then monitors for when any of the identified workbooks are opened (step 403). When a given workbook is opened, testing service 303 makes a copy of the workbook (step 405). Thus, the copy of the workbook resides in a pre-revision or original state. Testing service 303 monitors what revisions are made to the workbook (step 407), such as by watching requests flowing in from a spreadsheet application, receiving reports from a calculation engine, monitoring revision records, or in some other manner.

At least some of the revisions that are monitored are applied to the copy of the workbook (step 409). In some implementations, each and every revision that is made to an original workbook is applied to the copy of the workbook. However, in other implementations, only a subset of the revisions are applied to the copy of the workbook. For example, testing service 303 could apply just those revisions associated with components or some other aspect of an application service being tested.

Testing service 303 maintains a queue or list of revisions made to an original workbook while it is open. However, in some implementations the revisions are not applied to the copy of the workbook until the original workbook is closed. Once the original workbooks is closed and its revisions saved, testing service 303 opens the copy of the workbooks and applies the queue of revisions to it. As mentioned, in some scenarios all of the revisions may be applied, but in other scenarios just a subset of them are applied. The copy of the workbook can be closed and the revisions saved.

The original workbook and the copy of the workbook in their post-revision states are then compared by testing service 303 to evaluate any improvements to components or other aspects of a spreadsheet service that may have been made (step 411). Discrepancies between the original workbook in its revised state and the copy of the workbook in its revised state may indicate that bugs exist for which further analysis would be beneficial.

FIGS. 5-8 illustrate a workbook 501 identified for testing. Revisions are made to the workbook 501, which are illustrated in FIG. 6. FIG. 7 illustrates the responses thereto by components of a supporting spreadsheet service. FIG. 8 illustrates a test workbook 801 that is a copy of workbook 501. The same revisions made to workbook 501 are made to test workbook 801 and invoke responses by components under test in a version of the spreadsheet service. The responses are also illustrated in FIG. 8.

Referring to FIG. 5, workbook 501 includes various cells that form a spreadsheet, of which cell 503 is representative. Each cell is defined by a row and a column. The spreadsheet in workbook 501 initially includes rows r1-r6 and columns c1-c7. The cell r4c4, defined by row r4 and column c4, includes a formula 505 that adds the values in two other cells referenced in the formula (r2c4+r2c5). Workbook 501 also includes a feature menu 504 from which various features and functions may be selected, including a home menu, an edit menu, a design menu, a data menu, and a review menu.

In FIG. 6, various interactions or edits are made with respect to workbook 501, including a row insertion 601 and a column insertion 603. The row insertion 601 is made with respect to row r2 and the column insertion is made with respect to column c5. The revisions invoke responses by components of the spreadsheet service in which workbook 501 is hosted that function to ensure that formulas and other aspects of workbook 501 change in view of the revisions. FIG. 7 illustrates the responses to the revisions. Namely, the value previously held in cell r2c5 has been moved to cell r3c6. The value in previous held cell r2c4 has been moved down to cell r3c4. Lastly, the formula 505 held in cell r4c4 is moved from cell r4c4 to cell r5c4.

It may also be appreciated that the formula 505 itself is changed. Rather than referencing a cell with no value in it, the formula 505 is modified automatically by a component or components of the spreadsheet service to reference the cells to which the values previous referenced have moved. In other words, rather than reference cell r2c4 and cell r2c5, the formula correctly references cell r3c4 and cell r3c6.

The responses illustrated in FIG. 7 are representative of responses made by components of a live spreadsheet service in response to live changes or revisions made by users. FIG. 8 illustrates responses representative of those made by components under test with respect to a new or modified spreadsheet service.

FIG. 8 illustrates a test workbook 801 that corresponds to and is a copy of workbook 501. Test workbook 801 may be created at the time that workbook 501 opened. The revisions made to workbook 501 are tracked and, upon closing workbook 501, are applied to test workbook 801. The revisions are applied to test workbook 801 to test a version of a spreadsheet service that includes new or modified components. Discrepancies between workbook 501 and test workbook 801 may be indicative of bugs in the new spreadsheet service.

Any discrepancies between workbook 501 and test workbook 801 may be identified by comparing the two workbooks. A comparison of workbook 501 and test workbook 801 in their post-revision states reveals that formula 805 differs relative to formula 505. Rather than correctly changing the cell references in formula 805, an error has occurred. Formula 805 references cell r3c5 does not correctly reference cell r3c6. Accordingly, it may be concluded that the component or components in a new or updated version of a spreadsheet service that are responsible for changing formulas are buggy or otherwise sub-optimal.

FIG. 9 illustrates computing system 900, which is representative of any suitable computing system or collection of systems that may be employed to implement all or portions of a testing service 910. Examples of testing service 910 include testing service 101 and testing service 303. It may be appreciated that testing service 910 may be implemented on computing system 900 as a stand-alone service. However, testing service 910 may also be implemented in an integrated or cooperative fashion with other applications or services running on computing system 900, such as application service 911, or any other application for which testing service 910 may perform testing. Examples of application service 911 include but are not limited to document service 110, document service 120, spreadsheet service 311, spreadsheet service 321, and spreadsheet service 305.

Examples of computing system 900 include server computers, application servers, rack servers, web servers, cloud computing platforms, and data center equipment, as well as any other type of physical or virtual server machine, and any variation or combination thereof. In some implementations, a collection of multiple computing systems may be employed to implement all or portions of testing service 910 and application service 911, which may each be hosted in one or more data centers, virtual data centers, or any other suitable computing facilities.

Computing system 900 is also representative of any computing system suitable for implementing any client application, examples of which include document application 103, document application 105, and spreadsheet applications 333, 343, 353, and 363. In such situations, examples of computing system 900 also include, but are not limited to, desktop computers, laptop computers, tablet computers, notebook computers, mobile computing devices, smart phones, cell phones, media devices, and gaming devices, as well as any other type of physical or virtual computing machine.

Computing system 900 may be implemented as a single apparatus, system, or device or may be implemented in a distributed manner as multiple apparatuses, systems, or devices. Computing system 900 includes, but is not limited to, processing system 901, storage system 903, software 905, communication interface system 907, and user interface system 909. Processing system 901 is operatively coupled with storage system 903, communication interface system 907, and user interface system 909. User interface system 909 is optional in some implementations. Processing system 901 loads and executes software 905 from storage system 903. When executed by processing system 901, software 905 directs processing system 901 to operate as described herein for any one or more of testing service 101 and testing service 303, and optionally as described for any of the other operational scenarios disclosed herein. Computing system 900 may optionally include additional devices, features, or functionality not discussed for purposes of brevity.

Referring still to FIG. 9, processing system 901 may comprise a microprocessor and other circuitry that retrieves and executes software 905 from storage system 903. Processing system 901 may be implemented within a single processing device, but may also be distributed across multiple processing devices or sub-systems that cooperate in executing program instructions. Examples of processing system 901 include general purpose central processing units, application specific processors, and logic devices, as well as any other type of processing device, combinations, or variations thereof.

Storage system 903 may comprise any computer readable storage media readable by processing system 901 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which software 905 may be communicated internally or externally. Storage system 903 may be implemented as a single storage device, but may also be implemented across multiple storage devices or sub-systems co-located or distributed relative to each other. Storage system 903 may comprise additional elements, such as a controller, capable of communicating with processing system 901 or possibly other systems.

Software 905 may be implemented in program instructions and among other functions may, when executed by processing system 901, direct processing system 901 to operate as described herein as described with respect to the various operational scenarios disclosed herein. In particular, the program instructions may include various components or modules that cooperate or otherwise interact to carry out the various processes and operational scenarios described herein. The various components or modules may be embodied in compiled or interpreted instructions or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software or other application software. Software 905 may also comprise firmware or some other form of machine-readable processing instructions executable by processing system 901.

In general, software 905 may, when loaded into processing system 901 and executed, transform a suitable apparatus, system, or device (of which computing system 900 is representative) overall from a general-purpose computing system into a special-purpose computing system customized to facilitate enhanced testing as described herein for each implementation. Indeed, encoding software 905 on storage system 903 may transform the physical structure of storage system 903. The specific transformation of the physical structure may depend on various factors in different implementations of this description. Examples of such factors may include, but are not limited, to the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Referring again to FIG. 1 as an example, through the operation of a computing system or systems of which computing system 900 is representative, transformations may be performed with respect to a document. As an example, document 117 may be edited or otherwise revised. Testing service 101 creates a copy of document 117, represented by document 127, and applies the same revisions to document 127, thereby changing document 127 from a first, unrevised state to a second, revised state. In another example, given with respect to FIG. 3, workbook 328 is created and transformed from an unrevised state to a revised state. Other examples of transformations are possible and may be considered within the scope of the present disclosure.

It should be understood that computing system 900 is generally intended to represent a computing system or systems on which software 905 may be deployed and executed in order to implement enhanced testing. However, computing system 900 may also be suitable as any computing system on which software 905 may be staged and from where software 905 may be distributed, transported, downloaded, or otherwise provided to yet another computing system for deployment and execution, or yet additional distribution.

Communication interface system 907 may include communication connections and devices that allow for communication with other computing systems (not shown) over a communication network or collection of networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 900 and any other computing system (not shown) may occur over a communication network or networks and in accordance with various communication protocols, combinations of protocols, or variations thereof. Examples of communication networks over which computing system 900 may exchange information with other computing systems include intranets, the Internet, local area networks, wide area networks, wireless networks, wired networks, virtual networks, software defined networks, data center buses, computing backplanes, or any combination or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), Ethernet, as well as any other suitable communication protocol, variation, or combination thereof.

In any of the aforementioned examples in which information is exchanged between clients and servers, the exchange of information may occur in accordance with any of a variety of protocols. Examples of the protocols include, but are not limited to, FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

User interface system 909, which is optional, may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 909. In some cases, the input and output devices may be combined in a single device, such as a display capable of displaying images and receiving touch gestures. The aforementioned user input and output devices are well known in the art and need not be discussed at length here.

User interface system 909 may also include associated user interface software executable by processing system 901 in support of the various user input and output devices discussed above. Separately or in conjunction with each other and other hardware and software elements, the user interface software and user interface devices may support a graphical user interface, a natural user interface, or any other type of user interface.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of testing components in an application service comprising:
identifying revisions made to a document that invoke responses by the components in the application service;
applying the revisions to a test document to invoke test responses by test components corresponding to the components; and
evaluating the test components based at least in part on a comparison of the responses by the components to the test responses by the test components.

2. The method of claim 1 further comprising selecting the document for testing from a plurality of documents based at least in part on a relevance of the test components to each of the plurality of documents and monitoring for when the document is opened.

3. The method of claim 2 further comprising, in response to when the document is opened, creating the test document prior to any of the revisions occurring, wherein the test document comprises a copy of the document.

4. The method of claim 3 wherein identifying the revisions made to the document that invoke responses by the components in the application service comprises monitoring any revision that invokes a response by a component identified for development.

5. The method of claim 3 further comprising monitoring for when the document is closed, wherein applying the revisions to the test document comprises applying the revisions to the test document in response to when the document is closed.

6. The method of claim 1 further comprises comparing the document after the revisions are made to the test document after the revisions are made to generate the comparison of the responses by the components to the test responses by the test components.

7. The method of claim 1 wherein the application service comprises a spreadsheet application service, wherein the document comprises a spreadsheet workbook, and wherein the test document comprises a copy of the spreadsheet workbook.

8. The method of claim 7 wherein the revisions comprise an edit to a first portion of a spreadsheet in the spreadsheet workbook that implicates at least a second portion of the spreadsheet in the spreadsheet workbook, and wherein the responses by the components comprises at least one of the components effecting a change with respect to the second portion of the spreadsheet in response to the edit.

9. The method of claim 8 wherein the edit to the first portion of the spreadsheet comprises at least one of a row insertion, a row deletion, a column insertion, a column deletion, a cell value edit, and a formula edit, and wherein the change effected with respect to the second portion of the spreadsheet in response to the edit comprises at least one of changing a cell reference, changing a formula, and changing a cell value.

10. The method of claim 1 wherein the application service comprises one of a spreadsheet application service, a word processing application service, and a presentation application service, and wherein the document comprises one of a spreadsheet workbook, a word processing document, and a presentation document.

11. One or more computer readable storage media having program instructions stored thereon for testing components in an application service, wherein the program instructions, when executed by a processing system, direct the processing system to at least:
identify at least a subset of revisions made to a document that invoke responses by at least a subset of the components in the application service;
apply the subset of the revisions to a test document corresponding to the document to invoke test responses by test components corresponding to the subset of the components; and
evaluate the test components based at least in part on a comparison of the responses by the subset of the components to the test responses by the test components.

12. The one or more computer readable storage media of claim 11 wherein the program instructions further direct the processing system to select the document for testing from a plurality of documents based at least in part on a relevance of the test components to each of the plurality of documents and monitoring for when the document is opened.

13. The one or more computer readable storage media of claim 12 wherein the program instructions further direct the processing system to, in response to when the document is opened, create the test document prior to any of the revisions occurring, wherein the test document comprises a copy of the document.

14. The one or more computer readable storage media of claim 13 wherein to identify at least the subset of the revisions made to the document that invoke responses by at least the subset of the components in the application service, the program instructions direct the processing system to monitor the revisions for those that invoke responses by specific ones of the components identified for development.

15. The one or more computer readable storage media of claim 13 wherein the program instructions further direct the processing system to monitor for when the document is closed, wherein to apply the subset of the revisions to the test document, the program instructions direct the processing system to apply the subset of the revisions to the test document in response to when the document is closed.

16. The one or more computer readable storage media of claim 11 wherein the program instructions further direct the processing system to compare the document after the revisions are made to the test document after the revisions are made to generate the comparison of the responses by the subset of the components to the test responses by the test components.

17. The one or more computer readable storage media of claim 11 wherein the application service comprises a spreadsheet application service, wherein the document comprises a spreadsheet workbook, and wherein the test document comprises a copy of the spreadsheet workbook, and wherein the revisions comprise an edit to a first portion of a spreadsheet in the spreadsheet workbook that implicates at least a second portion of the spreadsheet in the spreadsheet workbook, and wherein the responses by at least the subset of the components comprises at least one of the subset of the components effecting a change with respect to the second portion of the spreadsheet in response to the edit.

18. The one or more computer readable storage media of claim 17 wherein the edit to the first portion of the spreadsheet comprises at least one of a row insertion, a row deletion, a column insertion, a column deletion, a cell value edit, and a formula edit, and wherein the change effected with respect to the second portion of the spreadsheet in response to the edit comprises at least one of changing a cell reference, changing a formula, and changing a cell value.

19. A method for testing code development in a spreadsheet service comprising:
identifying revisions made by a plurality of users collaborating on a spreadsheet, wherein the plurality of revisions invoked a plurality of responses by a plurality of components that provide at least a portion of the spreadsheet service;
applying the revisions to a copy of the spreadsheet to invoke a plurality of test responses a plurality of test components; and
comparing the spreadsheet after the revisions to the copy of the spreadsheet after the revisions to identify potential bugs associated with the plurality of test components.

20. The method of claim 19 wherein the spreadsheet service comprises a calculation engine and a rendering engine, wherein the plurality of components comprise a first subset of components for the calculation engine and a second subset of components for the rendering engine, and wherein the plurality of test components comprise new versions of the plurality of components.
